(19) United States
(12) Patent Application Publication
(10) Pub. No.: US 2014/0133675 A1
(43) Pub. Date: May 15, 2014

(54) Time Interval Sound Alignment

(71) Applicant: ADOBE SYSTEMS INCORPORATED, San Jose, CA (US)

(72) Inventors: Brian John King, Seattle, WA (US); Gautham J. Mysore, San Francisco, CA (US); Paris Smaragdis, Urbana, IL (US)

(73) Assignee: Adobe Systems Incorporated, San Jose, CA (US)

(21) Appl. No.: 13/675,844

(22) Filed: Nov. 13, 2012

(51) Int. Cl. H04R 3/12

(52) U.S. Cl. CPC H04R 3/12
USPC 381/97

(57) ABSTRACT

Time interval sound alignment techniques are described. In one or more implementations, one or more inputs are received via interaction with a user interface that indicate that a first time interval in a first representation of sound data generated from a first sound signal corresponds to a second time interval in a second representation of sound data generated from a second sound signal. A stretch value is calculated based on an amount of time represented in the first and second time intervals, respectively. Aligned sound data is generated from the sound data for the first and second time intervals based on the calculated stretch value.

### BACKGROUND

Sound alignment may be leveraged to support a wide range of functionality. For example, sound data may be captured for use as part of a movie, recording of a song, and so on. Parts of the sound data, however, may reflect capture in a noisy environment and therefore may be less than desirable when output, such as by being difficult to understand, interfere with desired sounds, and so on. Accordingly, parts of the sound data may be replaced by other sound data using sound alignment. Sound alignment may also be employed to support other functionality, such as to utilize a foreign overdub to replace the sound data with dialogue in a different language.

However, conventional techniques that are employed to automatically align the sound data may prove inadequate when confronted with disparate types of sound data, such as to employ a foreign overdub. Accordingly, these conventional techniques may cause a user to forgo use of these techniques as the results were often inconsistent, could result in undesirable alignments that lacked realism, and so forth. This may force users to undertake multiple re-recordings of the sound data that is to be used as a replacement until a desired match is obtained, manual fixing of the timing by a sound engineer, and so on.

### SUMMARY

Time interval sound alignment techniques are described. In one or more implementations, one or more inputs are received via interaction with a user interface that indicates that a first time interval in a first representation of sound data generated from a first sound signal corresponds to a second time interval in a second representation of sound data generated from a second sound signal. A stretch value is calculated based on an amount of time represented in the first and second time intervals, respectively. Aligned sound data is generated from the sound data for the first and second time intervals based on the calculated stretch value.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ time interval alignment techniques as described herein.

FIG. 2 depicts a system in an example implementation in which aligned sound data is generated from overdub sound data and reference sound data of FIG. 1 using time intervals.

FIG. 3 depicts a system in an example implementation in which an example alignment user interface is shown that includes representations of the overdub and reference sound data.

FIG. 4 depicts a system in an example implementation in which the example alignment user interface of FIG. 3 is shown as supporting interaction to manually specify time intervals.

FIG. 5 depicts a system in an example implementation in which the example alignment user interface is shown as including a result of aligned sound data generated based at least in part on the specified time intervals in FIG. 4.

FIG. 6 is a flow diagram depicting a procedure in an example implementation in which a user interface is output that is configured to receive inputs that specify corresponding time intervals in representations of sound data that are to be aligned.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

### Overview

Sound alignment techniques may be employed to support a variety of different functionality. For example, sound data having a higher quality may be synchronized with sound data having a lower quality to replace the lower quality sound data, such as to remove noise from a video shoot, music recording, and so on. In another example, a foreign overdub may be used to replace original sound data for a movie with dialogue in a different language. However, conventional auto-alignment systems could result in an output having incorrect alignment, could consume significant amounts of computing resources, and so on, especially when confronted with sound data having significantly different spectral characteristics, such as for a foreign overdub, to remove foul language, and so on.

Time interval sound alignment techniques are described herein. In one or more implementations, a user interface is configured to enable a user to specify particular time intervals of sound data that are to be aligned to each other. A stretch value is then calculated that defines a difference in the amount of time referenced by the respective time intervals. The stretch value is then used to stretch or compress the sound data for the corresponding time intervals to generate aligned sound data. In this way, these techniques may operate to align sound data that may have different spectral characteristics as well as promote an efficient use of computing resources. Further discussion of these and other examples may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

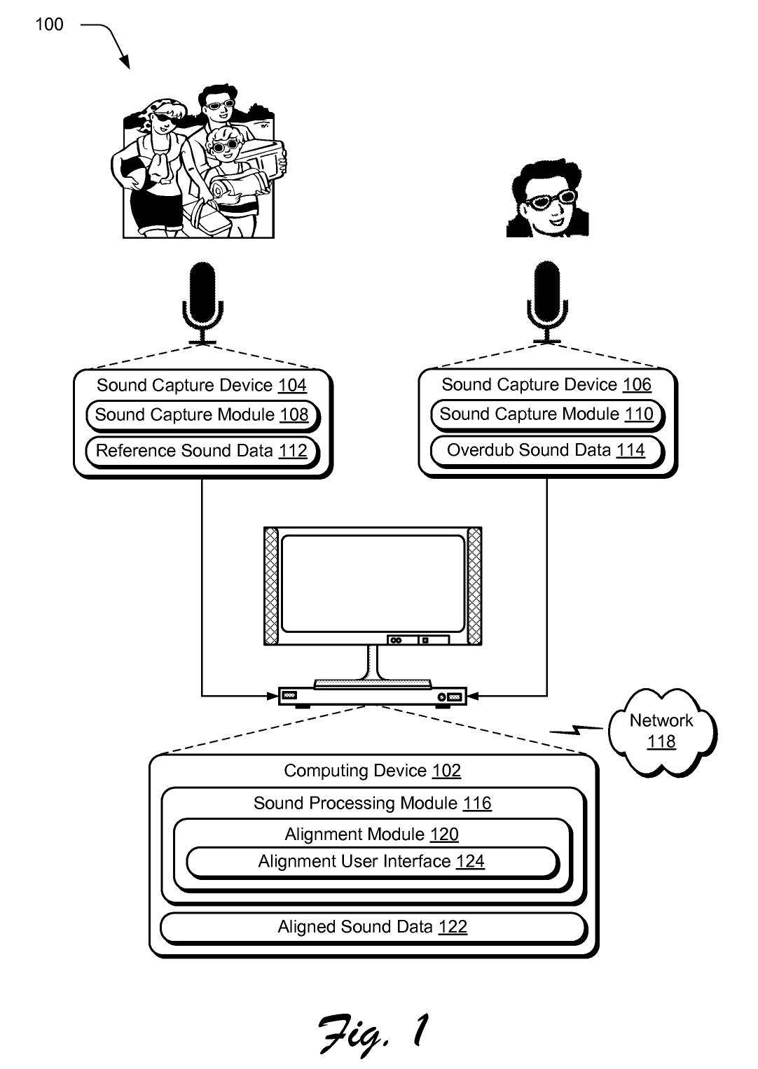

FIG. 1 is an illustration of an environment 100 in an example implementation that is operable to employ item interval sound alignment techniques described herein. The illustrated environment 100 includes a computing device 102 and sound capture devices 104, 106, which may be configured in a variety of ways.

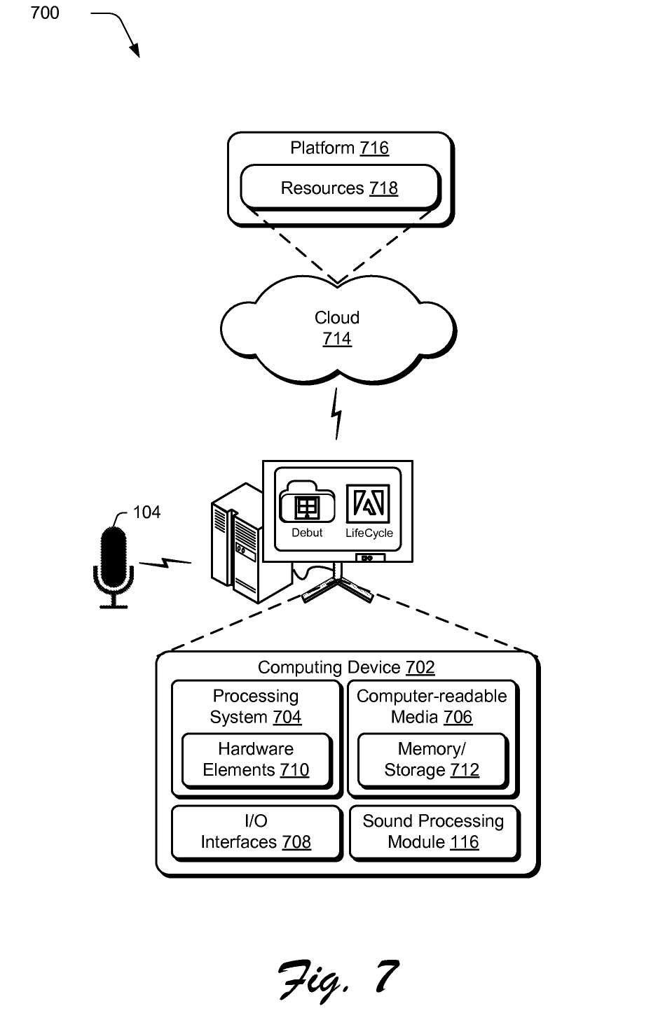

The computing device 102, for instance, may be configured as a desktop computer, a laptop computer, a mobile device (e.g., assuming a handheld configuration such as a tablet or mobile phone), and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices, such as multiple servers utilized by a business to perform operations “over the cloud” as further described in relation to FIG. 7.

The sound capture devices 104, 106 may also be configured in a variety of ways. Illustrated examples of one such configuration involves a standalone device but other configurations are also contemplated, such as part of a mobile phone, video camera, tablet computer, part of a desktop microphone, array microphone, and so on. Additionally, although the sound capture devices 104, 106 are illustrated separately from the computing device 102, the sound capture devices 104, 106 may be configured as part of the computing device 102, a single sound capture device may be utilized in each instance, and so on.

The sound capture devices 104, 106 are each illustrated as including respective sound capture modules 108, 110 that are representative of functionality to generate sound data, examples of which include reference sound data 112 and overdub sound data 114. Reference sound data 112 is utilized to describe sound data for which at least a part is to be replaced by the overdub sound data 114. This may include replacement of noisy portions (e.g., due to capture of the reference sound data 112 “outside”), use of a foreign overdub, and replacement using sound data that has different spectral characteristics. Thus, the overdub sound data 114 may be thought of as unaligned sound data that is to be processed for alignment with the reference sound data 112. Additionally, although illustrated separately for clarity in the discussion, it should be apparent that these roles may be satisfied alternately by different collections of sound data (e.g., in which different parts are taken from two or more files), and so on.

Regardless of where the reference sound data 112, and overdub sound data 114 originated, this data may then be obtained by the computing device 102 for processing by a sound processing module 116. Although illustrated as part of the computing device 102, functionality represented by the sound processing module 116 may be further divided, such as to be performed “over the cloud” via a network 118 connection, further discussion of which may be found in relation to FIG. 7.

An example of functionality of the sound processing module 116 is represented as an alignment module 120. The alignment module 120 is representative of functionality to align the overdub sound data 114 to the reference sound data 112 to create aligned sound data 122. As previously described, this may be used to replace a noisy portion of sound data, replace dialogue with other dialogue (e.g., for different languages), and so forth. In order to aid in the alignment, the alignment module 120 may support an alignment user interface 124 via which user inputs may be received to indicate corresponding time intervals of the reference sound data 112 to the overdub sound data 114. Further discussion of generation of the aligned sound data 122 and interaction with the alignment user interface 124 may be found in the following discussion and associated figure.

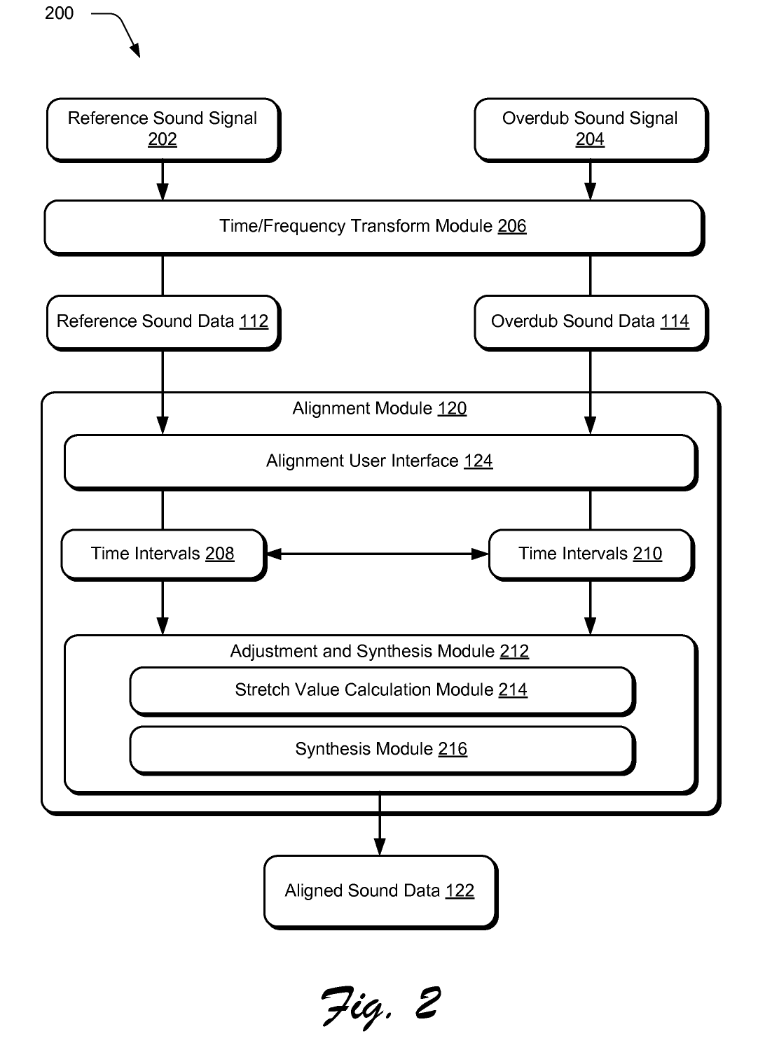

FIG. 2 depicts a system 200 in an example implementation in which aligned sound data 122 is generated from overdub sound data 114 and reference sound data 112 from FIG. 1. A reference sound signal 202 and an overdub sound signal 204 are processed by a time/frequency transform module 206 to create reference sound data 112 and overdub sound data 114, which may be configured in a variety of ways.

The sound data, for instance, may be used to form one or more spectrograms of a respective signal. For example, a time-domain signal may be received and processed to produce a time-frequency representation, e.g., a spectrogram, which may be output in an alignment user interface 124 for viewing by a user. Other representations are also contemplated, such as a time domain representation, an original time domain signal, and so on. Thus, the reference sound data 112 and overdub sound data 114 may be used to provide a time-frequency representation of the reference sound signal 202 and overdub sound signal 204, respectively, in this example. Thus, the reference and overdub sound data 112, 114 may represent sound captured by the devices.

Spectrograms may be generated in a variety of ways, an example of which includes calculation as magnitudes of short time Fourier transforms (STFT) of the signals. Additionally, the spectrograms may assume a variety of configurations, such as narrowband spectrograms (e.g., 32 ms windows) although other instances are also contemplated. The STFT sub-bands may be combined in a way so as to approximate logarithmically-spaced or other nonlinearly-spaced sub-bands.

Overdub sound data 114 and reference sound data 112 are illustrated as being received for output by an alignment user interface 124. The alignment user interface 124 is configured to output representations of sound data, such as a time or time/frequency representation of the reference and overdub sound data 112, 114. In this way, a user may view characteristics of the sound data and identify different portions that may be desirable to align, such as to align sentences, phrases, and so on. A user may then interact with the alignment user interface 124 to define time intervals 208, 210 in the reference sound data 112 and the overdub sound data 114 that are to correspond to each other.

The time intervals 208, 210 may then be provided to an adjustment and synthesis module 212 to generate aligned sound data 122 from the reference and overdub sound data 114. For example, a stretch value calculation module 214 may be employed to calculate a stretch value that describes a difference between amounts of time described by the respective time intervals 208, 210. The time interval 208 of the reference sound data 112, for instance, may be 120% longer than the time interval 210 for the overdub sound data 114. Accordingly, the sound data that corresponds to the item interval 210 for the overdub sound data 114 may be stretched by this stretch value by the synthesis module 216 to form the aligned sound data 122.

Results from conventional temporal alignment techniques when applied to sound data having dissimilar spectral characteristics such as foreign overdubs could include inconsistent timing and artifacts. However, the time interval techniques described herein may be used to preserve relative timing in the overdub sound data 114, and thus avoid the inconsistent timing and artifacts of conventional frame-by-frame alignment techniques that were feature based.

For example, if the reference and overdub sound data 112, 114 include significantly different features, alignment of those features could result in inaccuracies. Such features may be computed in a variety of ways. Examples of which include use of an algorithm, such as Probabilistic Latent Component Analysis (PLCA), non-negative matrix factorization (NMF), non-negative hidden Markov (N-HMM), non-negative factorial hidden Markov (N-FHMM), and the like. The time intervals, however, may be used to indicate correspondence between phrases, sentences, and so on even if having dissimilar features and may preserve relative timing of those intervals.

Further, processing performed using the time intervals may be performed using fewer computational resources and thus may be performed with improved efficiency. For example, the longer the clip, the more likely it was to result in an incorrect alignment using conventional techniques. Second, computation time is proportionate to the length of clips, such as the length of the overdub clip times the length of the reference clip. Therefore, if the two clip lengths double, the computation time quadruples. Consequently, conventional processing could be resource intensive, which could result in delays to even achieve an undesirable result.

However, efficiency of the alignment module 120 may also be improved through use of the alignment user interface 124. Through specification of the alignment points, for instance, an alignment task for the two clips in the previous example may be divided into a plurality of interval alignment tasks. Results of the plurality of interval alignment tasks may then be combined to create aligned sound data 122 for the two clips. For example, adding “N” pairs of alignment points may increase computation speed by a factor between “N” and “N²”. An example of the alignment user interface 124 is discussed as follows and shown in a corresponding figure.

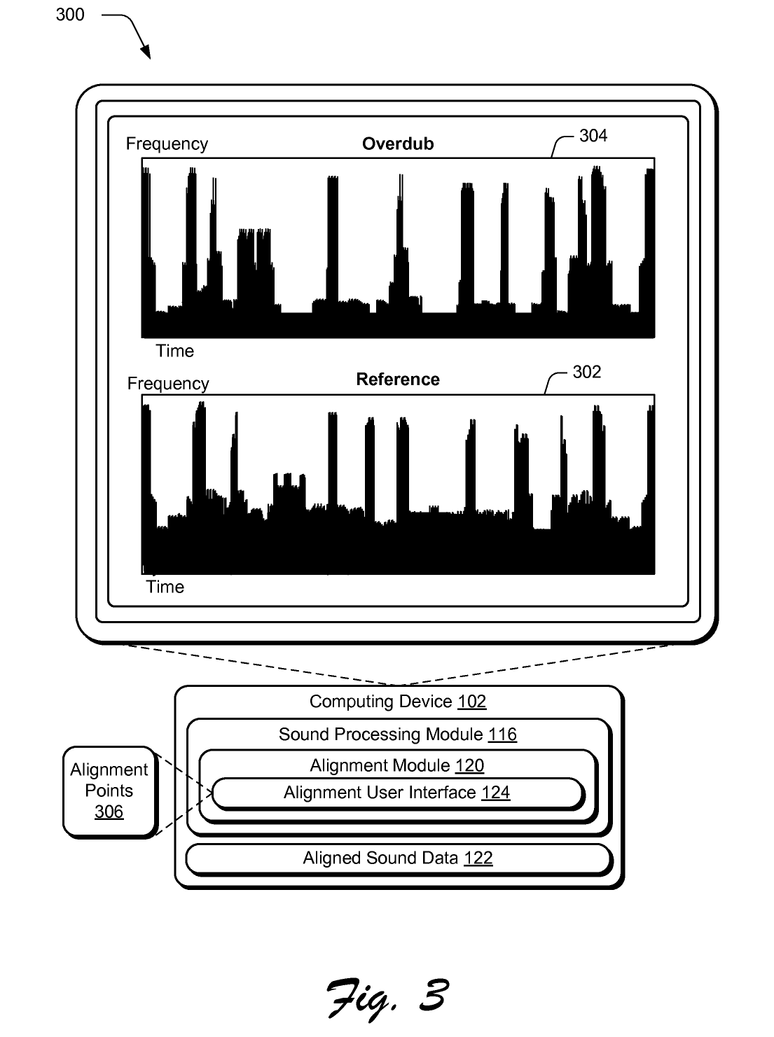

FIG. 3 depicts an example implementation 300 showing the computing device 102 of FIG. 1 as outputting an alignment user interface 124 for display. In this example, the computing device 102 is illustrated as assuming a mobile form factor (e.g., a tablet computer) although other implementations are also contemplated as previously described. In the illustrated example, the reference sound data 112 and the overdub sound data 114 are displayed in the alignment user interface 124 using respective time-frequency representations 302, 304, e.g., spectrograms, although other examples are also contemplated.

The representations 302, 304 are displayed concurrently in the alignment user interface 124 by a display device of the computing device 102, although other examples are also contemplated, such as through sequential output for display. The alignment user interface 124 is configured such that alignment points 306 may be specified to indicate correspondence of points in time between the representations 302, 304, and accordingly correspondence of sound data represented at those points in time. The alignment module 120 may then generated aligned sound data 122 as previously described based on the alignment points 306. The alignment points 306 may be specified in a variety of ways, an example of which is discussed as follows and shown in the corresponding figure.

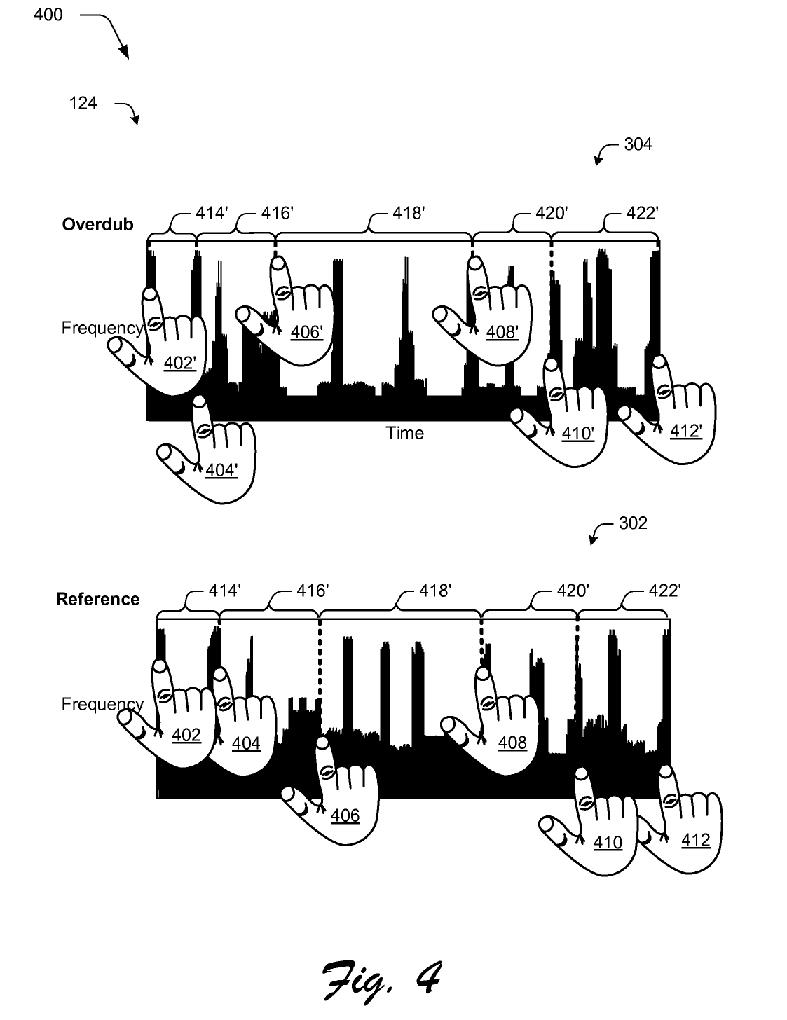

FIG. 4 depicts an example implementation 400 in which the representations of the reference and overdub sound data 302, 304 are utilized to indicate corresponding points in time. In this implementation 400, a series of inputs are depicted as be provided via a touch input, although other examples are also contemplated, such as use of a cursor control device, keyboard, voice command, and so on. Correspondence of the alignment points and time intervals is illustrated through use of a convention in which alignment point 402 of the representation 302 of the reference sound signal 112 corresponds to alignment point 402′ of the representation 304 of the overdub sound signal 114 and vice versa.

A user, when viewing the representations 302, 304 of the reference and overdub sound signals 112, 114 may notice particular points it time that are to be aligned based on spectral characteristics as displayed in the alignment user interface 124, even if those spectral characteristics pertain to different sounds. For example, a user may note that spectral characteristics in the representations 302, 304 each pertain to the beginning of a phrase at alignment points 402, 402′. Accordingly, the user may indicate such through interaction with the alignment user interface by setting the alignment points 402, 402′. The user may repeat this by selecting additional alignment points 404, 404′, 406, 406′, 408, 408′, 410, 410′, which therefore also define a plurality of time intervals 414, 414′, 416, 416′, 418, 418′, 420, 420′, 422, 422′ as corresponding to each other.

This selection, including the order thereof, may be performed in a variety of ways. For example, a user may select an alignment point 402 in the representation 302 of the reference sound data 112 and then indicate a corresponding point in time 402′ in the representation 304 of the overdub sound signal 114. This selection may also be reversed, such as by selecting an alignment point 402′ in the representation 304 of the overdub sound data 114 and then an alignment point 402 in the representation 302 of the reference sound data 112. Thus, in both of these examples a user alternates selections between the representations 302, 304 to indicate corresponding points in time.

Other examples are also contemplated. For example, the alignment user interface 124 may also be configured to support a series of selections made through interacting with one representation (e.g., alignment point 402, 404 in representation 302) followed by a corresponding series of selections made through interacting with another representation, e.g., alignment points 402′, 404′ in representation 302. In another example, alignment points may be specified having unique display characteristics to indicate correspondence, may be performed through a drag-and-drop operations, and so on. Further, other examples are also contemplated, such as to specify the time intervals 414, 414′ themselves as corresponding to each other, for which a variety of different user interface techniques may be employed.

Regardless of a technique used to indicate the alignment points for the time intervals, a result of this manual alignment through interaction with the alignment user interface 124 indicates correspondence between the sound data. This correspondence may be leveraged to generate the aligned sound data 122. An example of the alignment user interface 124 showing a representation of the aligned sound data 122 is discussed as follows and shown in the corresponding figure.

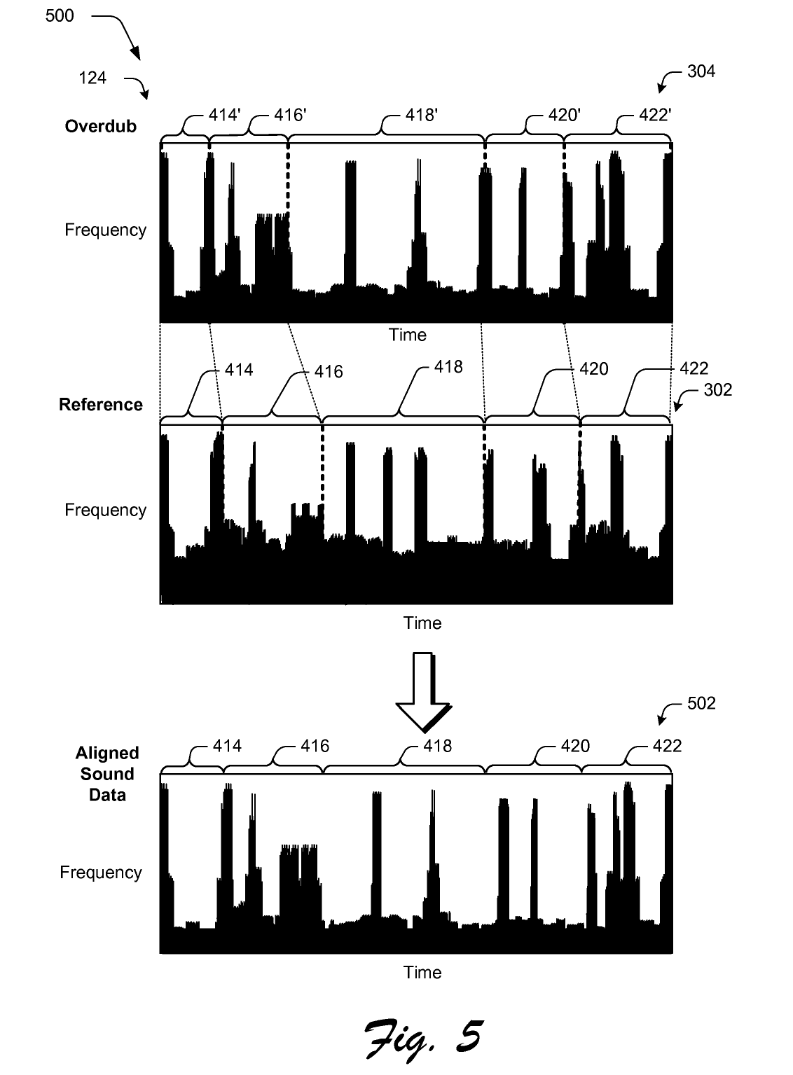

FIG. 5 depicts an example implementation 500 of the alignment user interface 124 as including a representation 502 of aligned sound data 122. As shown in the representations 302, 304 of the reference sound data 112 and the overdub sound data, time intervals 414-422 in the representation 302 of the reference sound data 112 have lengths (i.e., describe amounts of time) that are different than the time intervals 414′-422′ in the representation 304 of the overdub sound data 114. For example, interval 414 references an amount of time that is greater than interval 414′, interval 418 references an amount of time that is less than interval 418′, and so on. It should be readily apparent, however, that in some instances the lengths of the intervals may also match.

The alignment module 120 may use this information in a variety of ways to form aligned sound data 122. For example, the alignment points may be utilized to strictly align those points in time specified by the alignment points 306 for the reference and overdub sound data 112, 114 as corresponding to each other at a beginning and end of the time intervals. The alignment module 120 may then utilize a stretch value that is computed based on the difference in the length to align sound data within the time intervals as a whole and thereby preserve relative timing within the time intervals. This may include stretching and/or compressing sound data included within the time intervals as a whole using the stretch values to arrive at aligned sound data for that interval.

Additionally, processing of the sound data by interval may be utilized to improve efficiency as previously described. The alignment module 120, for instance, may divide the alignment task for the reference sound data 112 and the overdub sound data 114 according to the specified time intervals. For example, the alignment task may be divided into “N+1” interval alignment tasks in which “N” is a number of user-defined alignment points 306. Two or more of the interval alignment tasks may also be run in parallel to further speed-up performance. Once alignment is finished for the intervals, the results may be combined to arrive at the aligned sound data 122 for the reference sound data 112 and the overdub sound data 114. In one or more implementations, a representation 502 of this result of the aligned sound data 114 may also be displayed in the alignment user interface 124.

As shown in FIG. 5, for instance, the representation 302 of the reference sound data 114 may have different spectral characteristics than the representation 304 of the overdub sound data 114. This may be due to a variety of different reasons, such as a foreign overdub, to replace strong language, and so on. However, through viewing the representations 302, 304 a user may make note of a likely beginning and end of phrases, sentences, utterances, and so on. Accordingly, a user may interact with the alignment user interface 124 to indicate correspondence of the timing intervals. Stretch values may then be computed for the corresponding time intervals and used to adjust the time intervals in the overdub sound data 114 to the time intervals of the reference sound data 112. In this way, the aligned sound data 122 may be generated that includes the overdub sound data 114 as aligned to the time intervals of the reference sound data 112.

### Example Procedures

The following discussion describes user interface techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5.

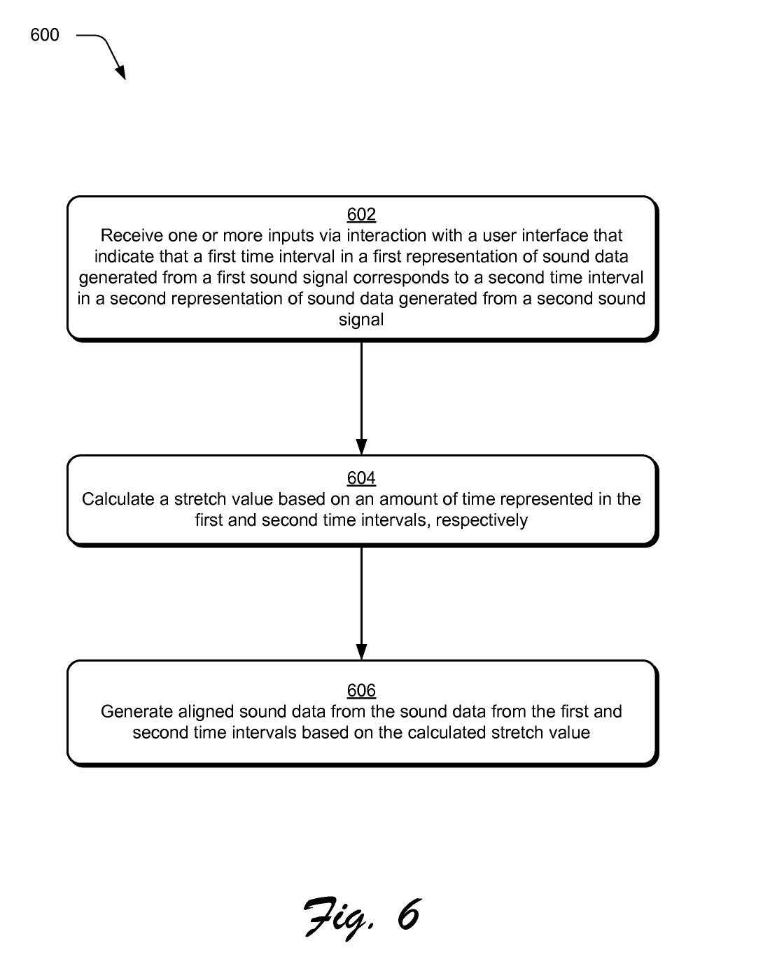

FIG. 6 depicts a procedure 600 in an example implementation in which a user interface in output that is usable to manually align particular time intervals to each other in sound data. One or more inputs are received via interaction with a user interface that indicate that a first time interval in a first representation of sound data generated from a first sound signal corresponds to a second time interval in a second representation of sound data generated from a second sound signal (block 602). As shown in FIG. 4, for instance, a user may set alignment points in a variety of different ways to define time intervals in respective representations 302, 304 that are to correspond to each other.

A stretch value is calculated based on an amount of time represented in the first and second time intervals, respectively (block 604). For example, the time intervals may describe different amounts of time. Accordingly, the stretch value may be calculated to describe an amount of time a time interval is to be stretched or compressed as a whole to match an amount of time described by another time interval. For example, the stretch value may be used to align a time interval in the overdub sound data 114 to a time interval in the reference sound data 112.

Aligned sound data is generated from the sound data for the first and second time intervals based on the calculated stretch value (block 606). The generation may be performed without computation of features and alignment thereof as in conventional techniques, thereby preserving relative timing of the intervals. However, implementations are also contemplated in which features are also leveraged, which may be used to stretch and compress portions with the time intervals, the use of which may be constrained by a cost value to still promote preservation of the relative timing, generally.

### Example System and Device

FIG. 7 illustrates an example system generally at 700 that includes an example computing device 702 that is representative of one or more computing systems and/or devices that may implement the various techniques described herein. This is illustrated through inclusion of the sound processing module 116, which may be configured to process sound data, such as sound data captured by an sound capture device 104. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more computing devices, the method comprising:
receiving one or more inputs via interaction with a user interface that indicate that a first time interval in a first representation of sound data generated from a first sound signal corresponds to a second time interval in a second representation of sound data generated from a second sound signal;
calculating a stretch value based on an amount of time represented in the first and second time intervals, respectively; and
generating aligned sound data from the sound data for the first and second time intervals based on the calculated stretch value.

2. A method as described in claim 1, wherein the one or more inputs define corresponding alignment points in the sound data generated from the first and second sound signals, respectively.

3. A method as described in claim 2, wherein the alignment points define a beginning and an end for a respective said time interval.

4. A method as described in claim 1, wherein the generating is performed without taking into account spectral characteristics identified in the sound data of the first and second time intervals, respectively.

5. A method as described in claim 1, wherein the first time interval defines an amount of time that is different from an amount of time defined by the second time interval.

6. A method as described in claim 1, wherein the one or more inputs are received responsive to user interaction with the user interface.

7. A method as described in claim 1, wherein the first and second representations describe time and frequency of the sound data generated from the first and second sound signals, respectively.

8. A method as described in claim 7, wherein the sound data from the first and second sound signals are computed using short time Fourier transforms.

9. A method as described in claim 1, wherein the sound data of the first time interval could have similar or different spectral characteristics than the sound data of the second time interval.

10. A system comprising:
at least one module implemented at least partially in hardware and configured to output a user interface that is usable to define a plurality of time intervals in representations of sound data generated from a plurality of sound signals as corresponding, one to another; and
one or more modules implemented at least partially in hardware and configured to generate aligned sound data from the sound data generated from the plurality of sound signals using the defined plurality of time intervals based on stretch values that define a difference in an amount of time represented by corresponding said time intervals.

11. A system as described in claim 10, wherein a first said time interval defined for a first said representation defines an amount of time that is the same or different that a second said interval for a second said representation.

12. A system as described in claim 10, wherein the one or more modules are configured to generate the aligned sound data by dividing an alignment task for the sound data generated from the plurality of sound signals into a plurality of interval alignment tasks that involve the time intervals that are defined as corresponding, one to another.

13. A system as described in claim 12, wherein at least two of the plurality of interval alignment tasks are configured to be executed in parallel by the one or more modules.

14. A system as described in claim 12, wherein the one or more modules are configured to generate the aligned sound data for the plurality of sound signals from a combination of results of the plurality of interval alignment tasks.

15. A system as described in claim 10, wherein the at least one module is configured to support the definition of the plurality of intervals by defining alignment points that define individual points in time in the plurality of representations that are to be aligned.

16. A system as described in claim 10, wherein the representations describe time and frequency of the sound data generated from respective ones of the plurality of sound signals.

17. One or more computer-readable storage media having instructions stored thereon that, responsive to execution on a computing device, causes the computing device to perform operations comprising:
outputting a user interface having a plurality of representations of sound data generated from respective sound signals;
receiving one or more inputs via interaction with the user interface that define a plurality of intervals in the plurality of representations as corresponding to each other;
calculating stretch values based on amount of time represented in corresponding said intervals; and
generating aligned sound data from the sound data for the corresponding said time intervals based on a respective said stretch value.

18. One or more computer-readable storage media as described in claim 17, wherein the one or more inputs define corresponding alignment points in the sound data generated from the first and second sound signals, respectively.

19. One or more computer-readable storage media as described in claim 18, wherein the alignment points define a beginning and an end for a respective said time interval.

20. One or more computer-readable storage media as described in claim 17, wherein the generating is performed without taking into account spectral characteristics identified in the sound data of the corresponding said time intervals.
